(19) United States
(12) Patent Application Publication
(10) Pub. No.: US 2016/0032668 A1
(43) Pub. Date: Feb. 4, 2016

(54) VACUUM SHAKER SYSTEMS

(71) Applicant: Daniel Guy POMERLEAU, (US)

(72) Inventors: Daniel Guy Pomerleau, Calgary (CA); Andrew Hicks, Canmore (CA)

(21) Appl. No.: 14/781,102

(22) PCT Filed: Mar. 24, 2014
(86) PCT No.: PCT/CA2014/000291

§ 371 Date: Sep. 29, 2015

Related U.S. Application Data
(60) Provisional application No. 61/806,870, filed on Mar. 30, 2013.

(51) Int. Cl. E21B 21/06; B01D 33/80; B01D 33/03

(52) U.S. Cl. CPC E21B 21/065; B01D 33/03; B01D 33/804

(57) ABSTRACT

The invention relates to improvements in vacuum shakers and more specifically to the integration of multiple shaker units to a common vacuum pump system, to apparatus for controlling the airflow through shaker screens, optimization of slurry transport, and to methods of separating drilling fluid from drill cuttings.

### FIELD OF THE INVENTION

The invention relates to improvements in vacuum shakers and more specifically to the integration of multiple shaker units to a common vacuum pump system, to apparatus for controlling the airflow through shaker screens, optimization of slurry transport, and to methods of separating drilling fluid from drill cuttings.

### BACKGROUND OF THE INVENTION

Screening machines to enhance the separation of solids and liquids have been used in various industries including the mining and oil industries for many years. As is well known, a screening machine typically includes a screen bed over which a solution containing fluids and solids is passed and then subjected to various separation forces including gravity and shaking. Each screen separation apparatus will utilize different types and sizes of screens to enable separation of different fluids/solids. In addition, the use of vacuum systems to improve separation within screening systems has also been implemented including the use of pulsed vacuum pressure.

Depending on the industry, the fluid/solid solutions being screened and the commercial objectives of the screening systems, different designs of screening machines exist. In different machines, certain functions have been incorporated into each machine for use within a specific industry or with specific solid/liquid solutions. The nuances of each general type of solid/liquid solution and each machine generally means that one type of machine will not be operative or effective within a different industry as, in many cases, unique problems exist in the handling of specific types of materials or solutions. For example many screening machine designs have been designed to optimize recovery of the solid materials from within a slurry; however, this format tends to ignore the quality of the recovered fluid. As such, it has generally not been considered how to effect separation of solids and liquids while maintaining or improving the quality of the fluid being recovered.

In the specific case of separating drilling fluid from drill cuttings, no commercially viable systems have been designed to provide effective pulsed vacuum assisted screening for the oil industry. That is, while various screening machines used in different industries propose such certain features, a review of such machines reveals that if used with modern drilling fluids, that significant processing issues would result.

In particular, vacuum systems for the separation of drilling fluid from drill cuttings have been effectively deployed in the field in recent years by the applicant. As described in Applicant's co-pending applications and incorporated herein by reference, the use of a vacuum force on a shaker system, when applied correctly can be highly effective in reducing drill fluid retained on cuttings (i.e. increase the quantity and quality of recovered drilling fluid) while also minimizing damage to drill cuttings which can result in contamination of the drilling fluid with fine solid materials that can pass through the screens. In particular, in past systems it has been determined that the control of airflow through a shaker screen in a manner that balances the forces being applied to the drilling fluid and to the drill cuttings is important to ensure that recovered drilling fluid does not contain an undesirable quantity of fines. It has been determined that fines within recovered drilling fluid will generally negatively affect the quality of the drilling fluid that is recovered.

Importantly, the above separation is achieved by controlling the air flow through the screen such that drilling fluid is effectively removed from the drill cuttings while ensuring that the drill cuttings do not stall on the screen. In addition, while it is desirable to minimize the formation of fines, a certain quantity of fines will always be present in the system which over time can cause significant problem to an operator. As such, previous systems of the Applicant have been designed to maintain sufficient airflow within drilling fluid recovery lines leading from a shaker to a vacuum storage tank where drilling fluid is recovered to prevent sedimentation of those fines in the recovery lines which will eventually lead to line plugging.

In other words, by controlling air flow such that stalling of drill cuttings does not occur on the screen minimizes the abrasion of drill cuttings with one another and thus helps prevent the formation of fines within the recovered drilling fluid.

While the foregoing vacuum techniques have been highly effective in reducing the amount of high value drilling fluid that is lost due to not being effectively removed from the drill cuttings and also has been effective in reducing the amount of downstream processing of the recovered drilling fluid, there continues to be a need to improve drilling fluid separation systems on shakers and methods of operating them.

For example, at most drilling rigs, multiple shaker systems are installed to simultaneously process drill cuttings from the rig. As is common practice, typically two or more shakers (often 3 or more and potentially up to 9 shakers) are configured to the drilling rig adjacent the blowout preventer (BOP). As drilling fluids and drill cuttings exit the well head, they are conveyed to the shakers via conduits to the possum belly of each the shakers. The conveyed cuttings and drilling fluids are generally split into separate flow streams at the well head in order that a relatively consistent amount of cuttings/fluid is delivered to each shaker.

Generally, it is preferred that for efficiency reasons (including both space and costs), that a single vacuum system is connected to the different shakers. That is, the connection of a single vacuum system to multiple shakers substantially reduces the installation time and costs of the system as well as the operation of the drilling fluid separation system.

Importantly, the vacuum systems are generally located at a level below the shakers to assist in the removal and collection of fluids and also to minimize the risk of plugging of the vacuum lines. The lines used to connect the shakers to the vacuum system are usually custom cut to length based on the specific layout of the vacuum system relative to shakers.

In operation, the flow of drilling fluid through the drillstring and wellbore will vary as drilling stops and starts during normal operations. That is, drilling and drill cuttings will generally be flowing during drilling as the drillstring is advancing downhole and will then cease for a period of a few minutes as each successive drill pipe is maneuvered into place. Thus, drilling fluid flow to the shakers will range from zero to an upper flow rate that will vary based on such factors as the rate of penetration (ROP), drilling fluid pumping rate and other factors. It is also typical that the time variation between zero flow rate and full flow rate is minimal.

During these ebbs and flows in drilling fluid, the shakers and vacuum systems will be operated at a generally consistent rate. That is, during a stoppage in drilling fluid flow rate, the shakers and vacuum systems will continue to operate at a fixed rate. Similarly, if there is a surge in drilling fluid flow, the shakers will also generally operate at a fixed rate.

As discussed above, the preferred position of the shakers is below the BOP with the vacuum pump system and fluid recovery systems below the shakers. The positioning of the vacuum lines beneath the shaker that lead to the lower vacuum pump system is helpful to ensure that solid particulate that may enter the vacuum lines will flow and be able to be removed from the system along with the recovered drilling fluid.

However, with multiple shakers connected together and with varying lengths of vacuum hose that may be configured to the shakers, there remains a problem in preventing the plugging of vacuum lines over time as maintaining high velocity flow through each of the vacuum lines may be problematic particularly when multiple systems are configured together.

As such, there continues to be a need for systems that improve the effectiveness and the ability to tune the vacuum systems for the wide range of operating conditions that may be experienced in the field and also in the deployment situation where multiple systems are configured together.

In addition, the nature of recovered drilling fluid may change dramatically as drilling advances through different formations. Various drilling parameters may be changed including the rate of penetration (ROP) and/or weight-on-bit (WOB) and drilling fluid flow rate. As a result, and depending on the formation, the consistency and nature of the drilling fluid/drill cuttings may change over the course of a relatively short period of time. For example, softer formations with a higher ROP may result in larger drilling cuttings whereas a harder formation with a lower ROP may result in smaller drill cuttings.

As such, an operator may choose to use coarser shaker screens (i.e. having a mesh size of API 100) which will allow for cuttings smaller than 130 microns to pass through the screens. In other formations and drilling conditions, the average particle size may allow the use of finer screens having a mesh size as small as API 325 which allow for particles of less than 44 microns to pass through the screens. Given typical distribution curves for solids in drilling fluid not only do the coarser (i.e. 100 mesh) screens allow for larger particles to pass through the screens but also more particles. Thus, when conveying recovered fluids using a vacuum assisted shaker, it is a fact that vacuum recovery transport line sedimentation can be particularly difficult with the larger screen openings. As a result, the need to ensure the movement of solids in the transport lines is very important. Solids movement in the transport lines is accomplished by maintaining high air velocities in the transport lines. However, maintaining a high air velocity in the transport lines results in higher vacuum pressures at the manifold and tends to cause stalling of the drill cuttings on the shaker screens. In pulsed screen systems that have been used previously, this problem is even more difficult as an operator is attempting to slow or temporarily stall the cuttings on the screen and then release them while at the same time maintain high air velocities in the slurry transport lines. Further still, when finer screens are used (i.e. API 325 mesh), the surface tension between the fluid and the screen cannot be overcome readily by the acceleration, amplitude and mass combination of the shaker basket. So while a coarser screen (i.e. API 100 mesh) allows more solids through and creates transport recovery line issues, finer screens (i.e. API 325 mesh) results in larger quantity of solids and increased fluid depth on the screen which complicates issues of screen plugging when a continuous vacuum is applied.

In addition, the relative proportion of drill cuttings within a recovered drilling fluid may be different. For example, a particular drilling fluid flow rate, drilling parameters and formation may result in a drilling fluid/drill cuttings ratio of about 20:1 whereas a different set of parameters may result in a drilling fluid/drill cuttings ratio of about 5:1. Moreover, the drilling fluids that may be utilized within a well may have different viscosities. As a result of all these parameters, the properties of the drilling fluid/drill cuttings mixture hitting a shaker screen will be likely be varying over time such that the handling of the mixture should be varied in order to optimize the drilling fluid/drill cuttings separation.

As noted above, the prior art has proposed different techniques to effect the separation of solids and liquids on a screen in different industries.

For example, U.S. Pat. No. 2,462,878 teaches a shaker screen device having a vacuum system that may be pulsed. The system includes an inclined screen bed onto which a slurry water and fine particles are placed. The system is operated to form a cake on the screen (the value component) such that fine particles are aggressively held against the screen by the force of the vacuum. The pulsing vacuum force is applied to prevent blinding off the end of the shaker and to ensure that a tight cake is formed on the shaker bed. That is, the vacuum must be applied to ensure that the slurry is completely dried before it reaches the end of the shaker so as to prevent the wet slurry from travelling off the end of the shaker. This patent also does not teach a means of controlling sedimentation in the vacuum lines. Further, this design indicates that when atmospheric pressure is allowed into the screen manifold that the vacuum line is closed so that the airflow rate between the pulsing device and the vacuum falls to zero velocity. This condition would result in line sedimentation and plugged off flow in the transport lines very quickly.

U.S. Pat. No. 3,970,552 describes a system for applying a vacuum to a shaker screen in order to form a cake of solid material on the screen. As in U.S. Pat. No. 2,462,878, the value component being recovered is the solid material on the screen and not the liquid component passing through the screen. As such, the patent teaches applying an aggressive vacuum to the screen to ensure that a cake is formed. As a result, the quality of the recovered fluid is of no importance in that fines will be created that are necessarily subjected to additional processing to enable the return of the valuable solid material back to the screen. In addition, in this system, the vacuum system does not convey both air and liquid components through a common vacuum line.

Canadian Patent 2,664,173 teaches a degassing shaker system that describes applying a pulsed vacuum to a shaker screen but does not specify the conditions or location for the pulsing device. Moreover, the patent does not describe sealing the sump to the atmosphere and thus, this system cannot effectively control the vacuum pressure within the sump as the pressure will neutralize with atmospheric pressure. This patent also does not teach a means of controlling sedimentation in the vacuum lines.

### SUMMARY OF THE INVENTION

In accordance with the invention, there is provided a vacuum shaker system for separating a mixture of a drilling fluid from drill cuttings on a shaker screen, the vacuum shaker system comprising: a first vacuum manifold operatively connected and substantially sealed to a portion of a shaker screen deck of a first shaker, the shaker screen deck supporting at least one shaker screen; a vacuum pump having an air/fluid separation system operatively connected to the first vacuum manifold through a first vacuum hose, the vacuum pump operable to draw air sufficient air through the first vacuum hose to move a slurry of drilling fluid and fine solids through the first vacuum hose and to apply a vacuum pressure to the underside of the shaker screen deck through the first vacuum hose; and a first bleed valve operatively connected to the first vacuum hose adjacent the first vacuum manifold wherein the first bleed valve is operable to control the flow of air through the first vacuum manifold and wherein for a given vacuum pump flow rate, air flow is sufficient to move a slurry of drilling fluid and fine solids through the first vacuum hose and wherein restricting air flow through the first bleed valve increases vacuum pressure within the first vacuum manifold and opening air flow through the first bleed valve reduces vacuum pressure within the manifold while maintaining sufficient air flow within the first vacuum line to move a slurry of drilling fluid and fine solids through the first vacuum hose.

In another embodiment, the system also includes a first pulse valve operatively connected to the first vacuum hose between the first bleed valve and first manifold, the first pulse valve operable to vary the vacuum pressure within the first manifold.

In another embodiment, the system further includes a second bleed valve operatively connected to the first vacuum hose between the first bleed valve and the vacuum pump and wherein adjustment of the second bleed valve enables coarse control of the relative air flow through the first vacuum manifold.

The vacuum shaker system may also include a second pulse valve operatively connected to the first vacuum hose adjacent the second bleed valve.

In another aspect, the vacuum shaker system couples an additional shaker where the second shaker is operatively connected to the vacuum pump. In this configuration, the second shaker includes: a second vacuum manifold operatively connected and substantially sealed to a portion of a shaker screen deck of the second shaker, the second shaker screen deck supporting at least one shaker screen; a second vacuum hose operatively connected to the second vacuum manifold and to the first vacuum hose and wherein the first and second vacuum hoses are operatively connected to the vacuum pump through a common third vacuum hose; and a second shaker bleed valve operatively connected to the second vacuum hose adjacent the second vacuum manifold wherein the second shaker bleed valve is operable to control the flow of air through the second vacuum manifold and wherein for a given vacuum pump flow rate, air flow is sufficient to move a slurry of drilling fluid and fine solids through the second vacuum hose and wherein restricting air flow through the second shaker bleed valve increases vacuum pressure within the second vacuum manifold and opening air flow through the second shaker bleed valve reduces vacuum pressure within the second manifold while maintaining sufficient air flow within the second vacuum hose to move a slurry of drilling fluid and fine solids through the second vacuum hose.

The vacuum shaker system may also include a second shaker pulse valve operatively connected to the second vacuum hose between the second shaker bleed valve and second manifold, the second shaker pulse valve operable to vary the vacuum pressure within the second manifold. The second bleed valve may be operatively connected to the first and second vacuum hoses. Further, the second pulse valve may be operatively connected to the first and second vacuum hoses adjacent the second bleed valve.

In another embodiment, the system further includes a baffle operatively connected within the first and second vacuum hoses to prevent airflow/vacuum tugging between the first and second manifolds.

In another aspect, the vacuum shaker system may further include: a particle size measuring device operatively connected to the first shaker deck for measuring average particle size of particles on the shaker deck; and a controller operatively connected to the particle size measuring device and the first bleed valve wherein the controller adjusts air flow through the first bleed valve based on a measured average particle size to change the vacuum pressure within the first manifold.

The controller may be operatively connected to the first pulse valve and the controller opens and closes the first pulse valve to provide a vacuum pressure profile within the first manifold. A pressure sensor may also be operatively connected to the first vacuum manifold and controller for providing pressure data to the controller. A mass flow meter may be operatively connected to the first shaker deck and controller for providing mass flow data to the controller.

In another aspect, the invention provides a method of maintaining solids flow within a vacuum system operatively connected to a shaker and controlling vacuum pressure with a vacuum manifold operatively connected to a shaker bed and shaker screen of a shaker, the shaker having a vacuum pump operatively connected to the vacuum manifold by a vacuum hose, the vacuum hose including a bleed valve adjacent the vacuum manifold, the method comprising the steps of: a) operating the vacuum pump to maintain a high air flow rate within the vacuum hose between the vacuum pump and the bleed valve; and b) adjusting the bleed valve to maintain an air flow rate sufficient to ensure the flow of liquids and fine solids within the vacuum line between the bleed valve and the vacuum pump and to maintain a desired pressure within the vacuum manifold.

In another embodiment, the shaker includes a pulse valve located adjacent the vacuum manifold between the bleed valve and vacuum manifold, and the method further includes the step of controlling the pulse valve to provide a vacuum pressure profile within the vacuum manifold.

In another embodiment, the method includes the step of measuring the average particle size of drill cuttings on the shaker bed and adjusting any one of or a combination of the bleed valve or pulse valve to change the pressure and/or pressure profile within the vacuum manifold.

In another embodiment, the method further includes the steps of measuring the relative speed of drill cuttings on the shaker and adjusting any one of or a combination of the bleed valve or pulse valve to change the pressure and/or pressure profile within the vacuum manifold.

In a still further embodiment, the method includes the step of correlating the average particle size and the relative speed of drill cuttings on the shaker and adjusting any one of or a combination of the bleed valve or pulse valve to change the pressure and/or pressure profile within the vacuum manifold based on the relative size and speed of the drill cuttings.

In yet another embodiment, the method includes the step of adjusting the frequency of opening and closing the pulse valve to control the time that drill cuttings are stalled on the shaker screen.

### BRIEF DESCRIPTION OF THE DRAWINGS

The invention is described with reference to the accompanying figures in which:

FIG. 1 is a schematic diagram of a single shaker configured to a vacuum system having a pulse valve and bleed valves in accordance with one embodiment of the invention;

FIG. 1A is a schematic diagram of a single shaker configured to a vacuum system having bleed valves in accordance with one embodiment of the invention;

FIG. 1B is a schematic diagram of a single shaker configured to a vacuum system having a pulse valve and bleed valves in accordance with one embodiment of the invention;

FIG. 1C is a schematic diagram of a single shaker configured to a vacuum system having pulse valves and bleed valves in accordance with one embodiment of the invention;

FIG. 2 is a schematic diagram of two shakers configured to a single vacuum system with bleed and pulse valves in accordance with one embodiment of the invention;

FIG. 2A is a schematic diagram of two shakers configured to a single vacuum system with bleed valves in accordance with one embodiment of the invention;

FIG. 2B is a schematic diagram of two shakers configured to a single vacuum system with pulse valves and bleed valves in accordance with one embodiment of the invention;

FIG. 2C is a schematic diagram of two shakers configured to a single vacuum system with a pulse valve and bleed valves in accordance with one embodiment of the invention;

FIGS. 3A-3C are representatives graphs showing the pressure vs. time profile within a vacuum manifold under different operating conditions in accordance with various embodiments of the invention; and,

FIG. 4 is a schematic diagram of a particle size measurement system and vacuum pressure control system in accordance with one embodiment of the invention.

### DETAILED DESCRIPTION OF THE INVENTION

With reference to the figures, systems, apparatus and methods of controlling the quality and quantity of recovered drilling fluid from a shaker are described.

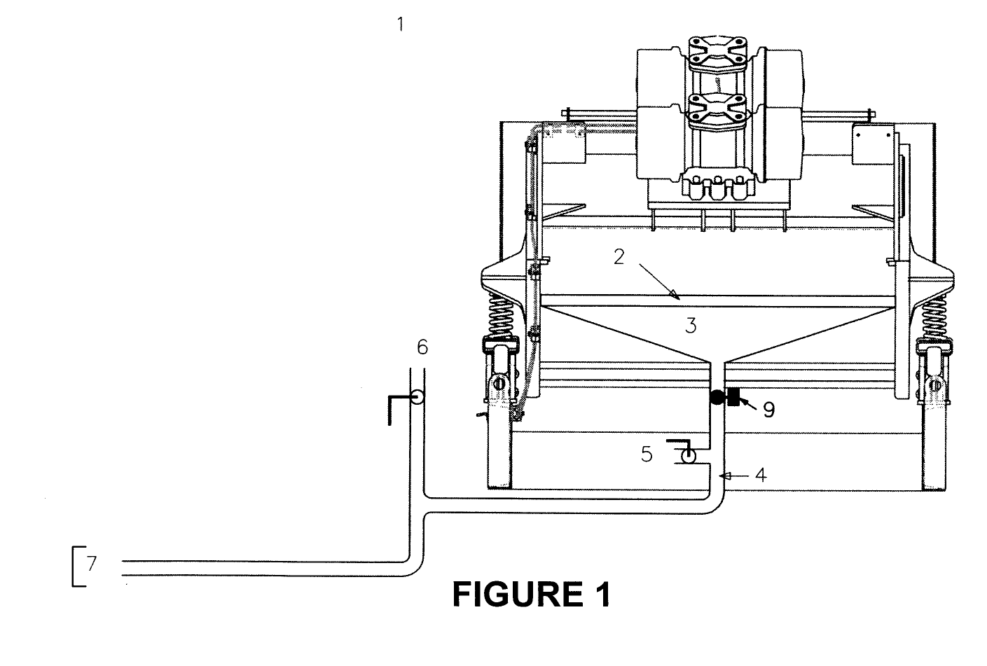

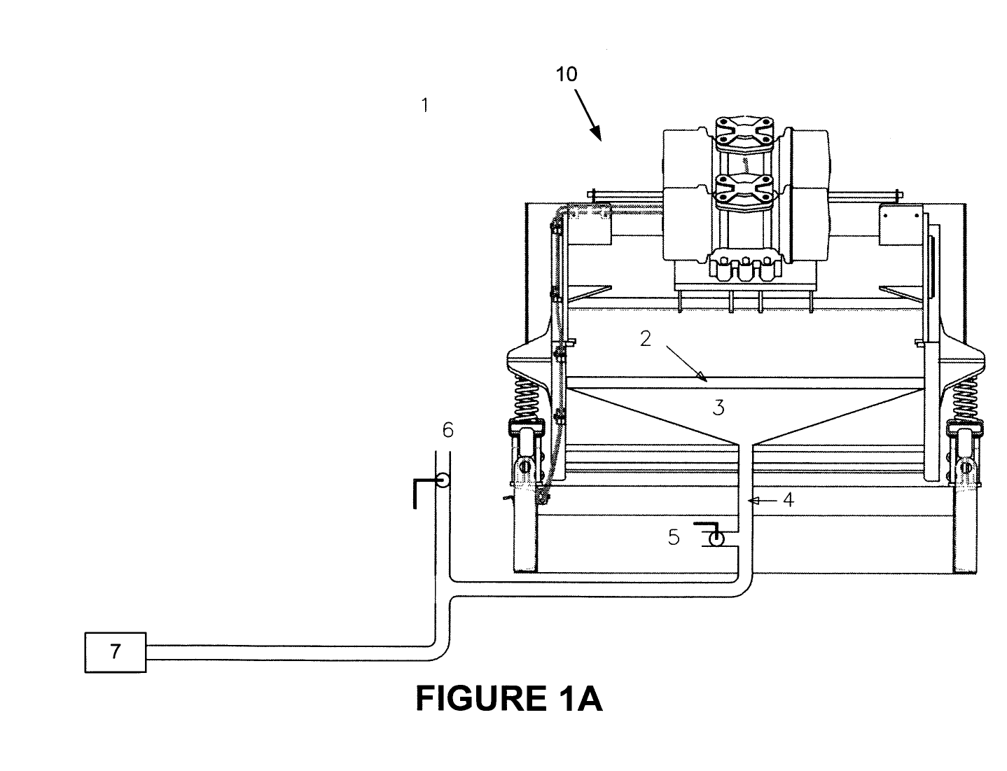

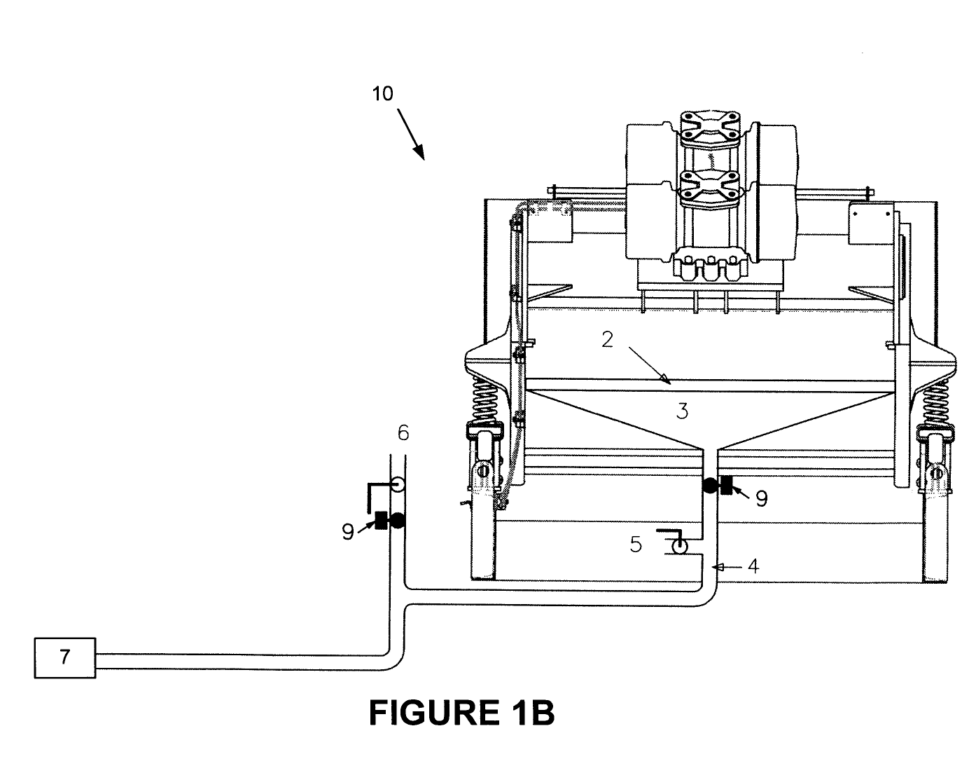

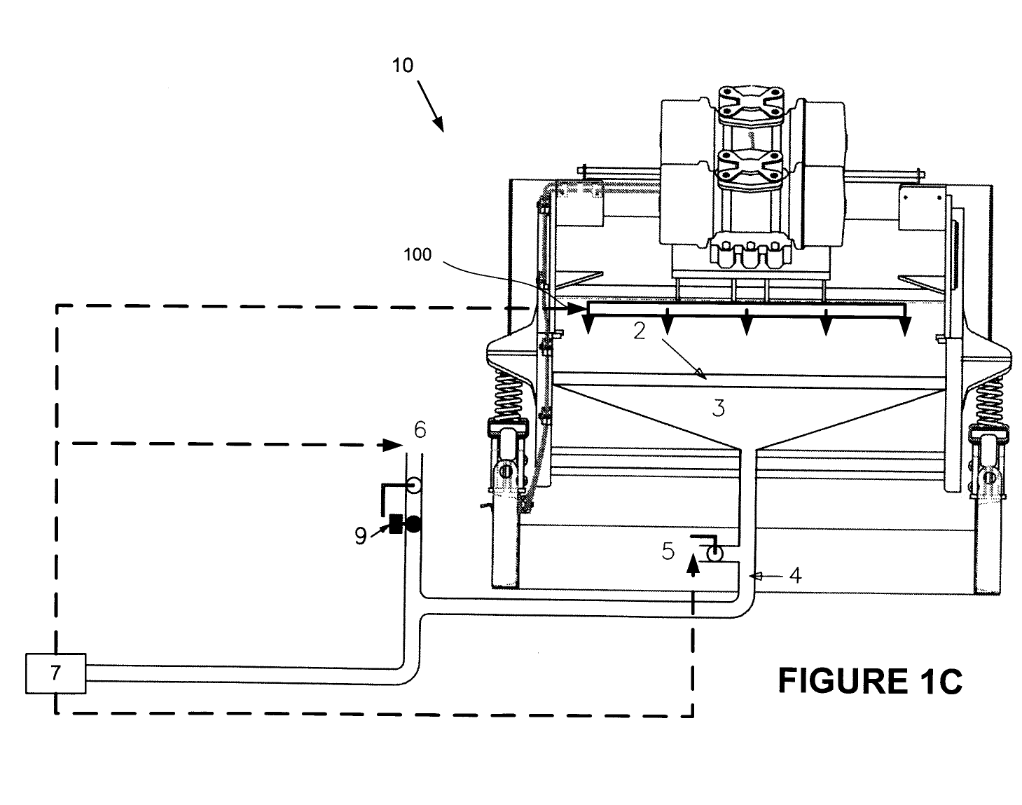

In a first embodiment as shown in FIG. 1, a drill cuttings/drill fluid shaker 10 is shown configured to a vacuum system 7. As described in Applicant's co-pending applications, the vacuum system 7 includes a fluid/air separator that enables the separation of fluid and air. The shaker includes a screen bed 2 supporting a number of shaker screens along the shaker bed. The shaker includes a vacuum manifold 3 operatively attached to at least one of the shaker screens or a portion of one of the shaker screens through the shaker bed. The vacuum manifold vibrates with the shaker bed and includes vacuum lines 4 that are connected to a vacuum pump system 7. The vacuum pump system can be operated to draw air through each manifold and each screen or a portion of one screen as drill cuttings and drill fluid are passed over one or more shaker screens on the shaker bed. Typically, the vacuum manifold 3 is configured to the downstream edge of the shaker bed such that the drill cuttings passing over the shaker are subjected to the vacuum pressure over a relatively small distance of the overall length of the shaker bed. That is, a typical shaker bed may be approximately 10 feet long and 4 feet wide wherein the vacuum is preferably applied to the last 3-36 inches of the shaker bed (preferably about 24 inches). As such, the manifold will have typical dimensions of 48 inches wide (corresponding to the width of the shaker bed) and 3-36 inches long.

FIGS. 1A-1C also show a single shaker configured to a vacuum system.

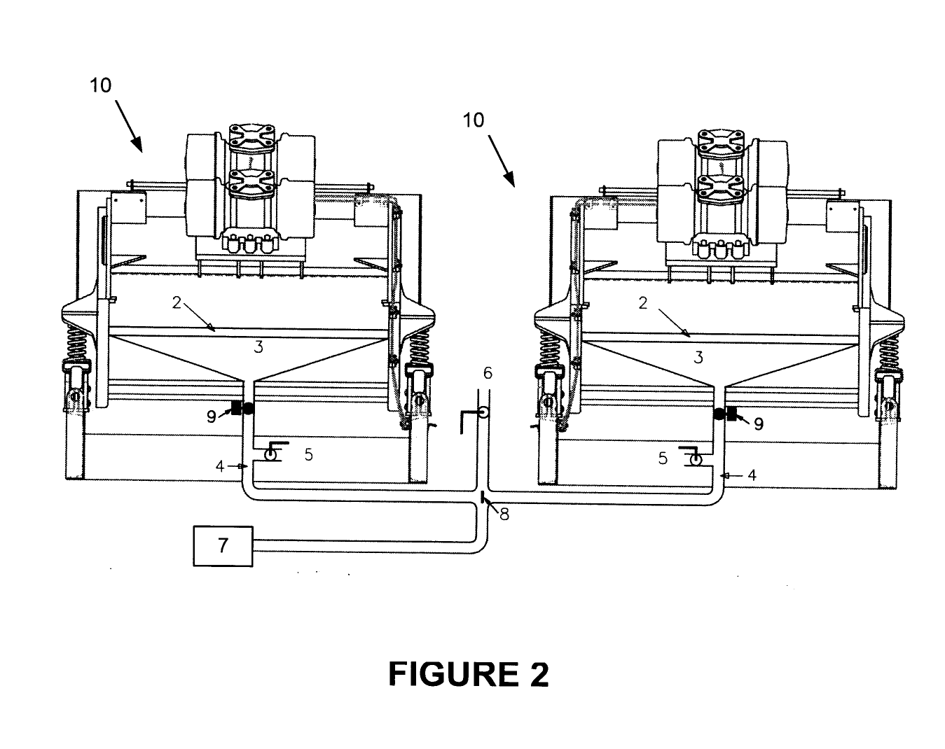

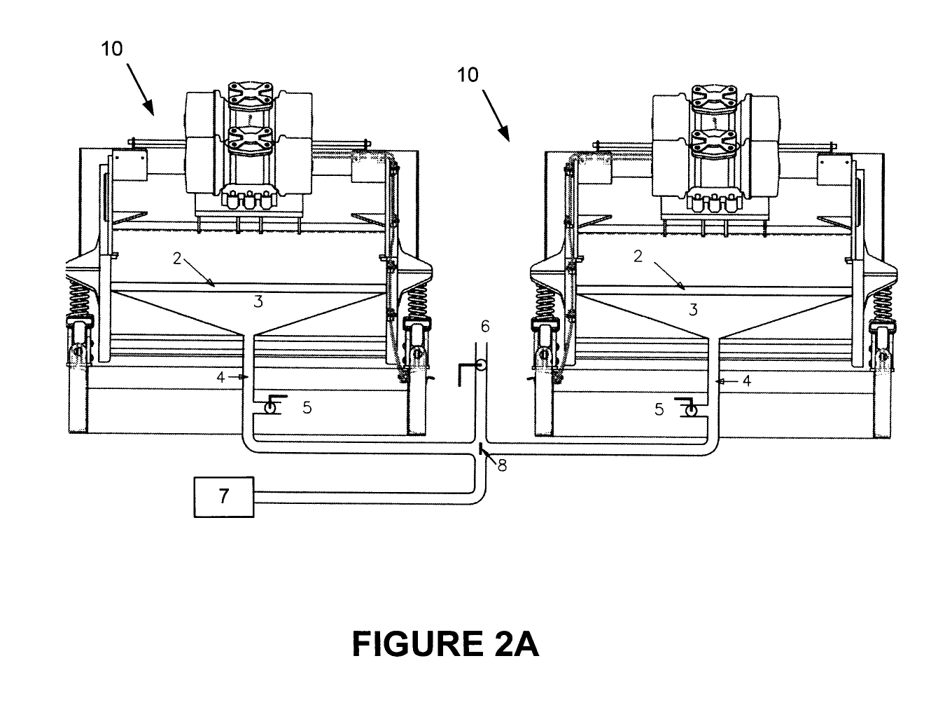

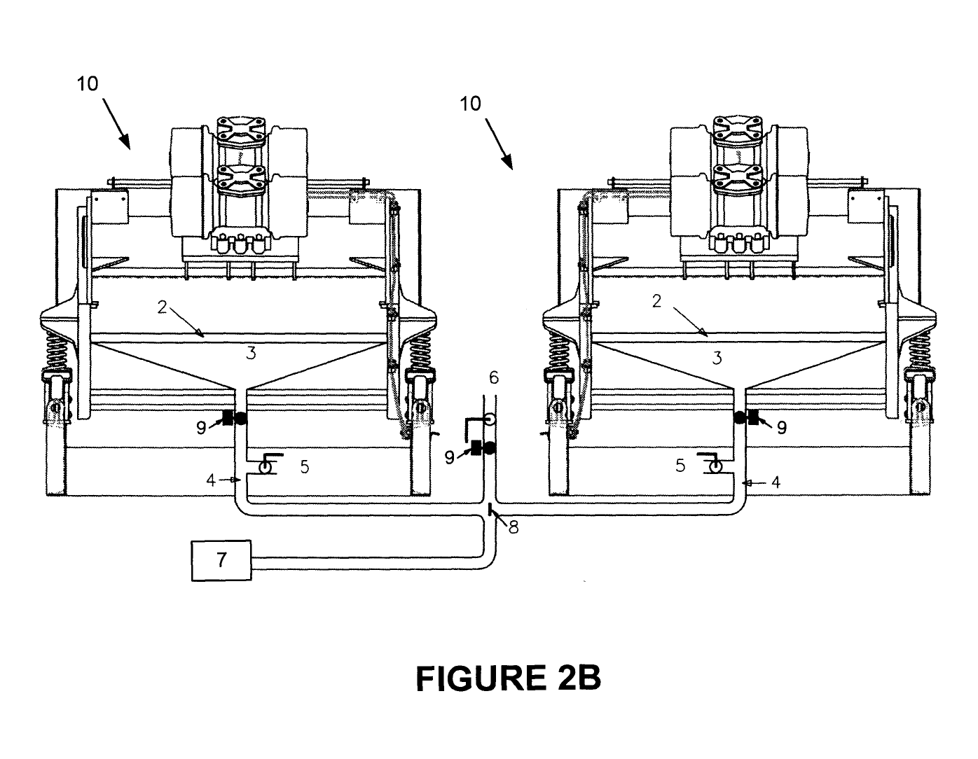

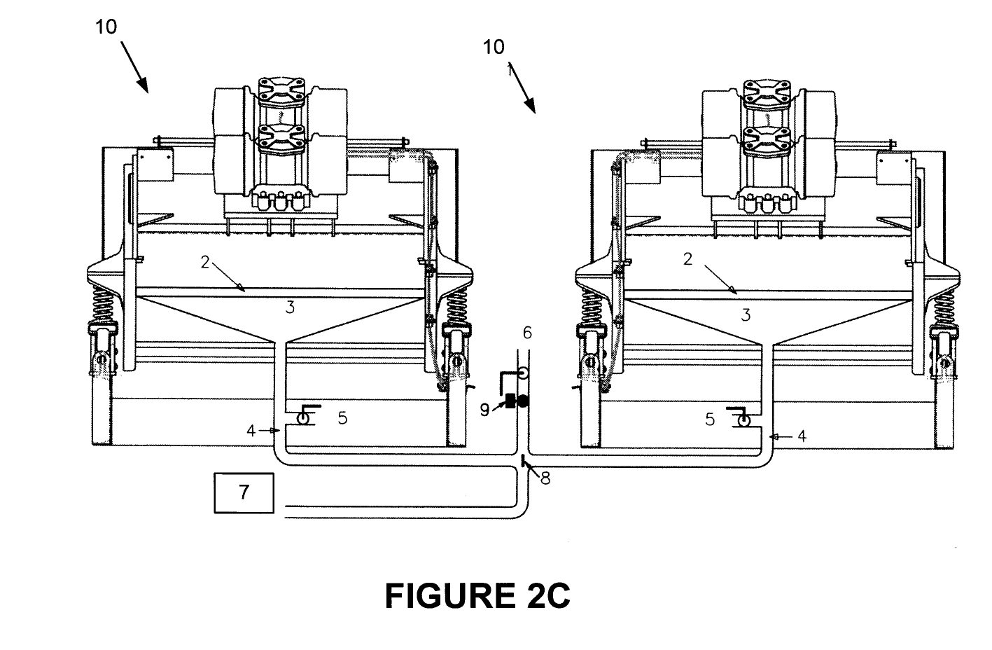

FIGS. 2, 2A, 2B and 2C show two shakers 10 as described above configured to a single vacuum system 7.

In accordance with the prior art, the vacuum system is operable to draw air through the shaker screen such that an effective amount of air passes through the screen to remove drilling fluid from the drill cuttings without stalling drill cuttings on the screens. Preventing the cuttings from stalling on the screen is important to minimize damage to drill cuttings by minimizing the ability of the cuttings to abrade one another if they are locked or stalled on the screen and being impacted by other cuttings. Damage to the drill cuttings will result in the formation of fines which may pass through the screen and which degrades the quality of recovered drilling fluid. In addition, the formation of fines can lead to other downstream handling problems and costs including sedimentation in the vacuum lines, additional downstream processing costs to remove the fines and/or the need or requirement to add additional chemicals to the drilling fluid to overcome the effects of the fines within the drilling fluid.

While preventing the stalling of drill cuttings on a shaker is generally desirable, it has been observed that under various operating conditions, the performance of the shaker can be improved further by varying the vacuum force over a period of time such that the vacuum force being applied ranges from a high value to a low value by pulsing the vacuum pressure thereby allowing for the slowing or momentary stalling of the cuttings and then the subsequent release.

In particular, a slurry of drill cuttings and drill fluid recovered from a well is highly variable in terms of average particle size of drill cuttings. That is, particle sizes can range from a sub-micron size up to large particles having diameters in the range of >1 inch. As such, the different particles all behave differently on a shaker bed. For example, at a fixed vibration rate larger sized particles will typically transit the shaker bed more quickly as with each vibration of the shaker bed, larger particles will generally be thrown further down the shaker bed as a result of the momentum these larger particles carry as they start to move. Moreover, larger particles will generally “break out” of the bulk drilling fluid more quickly as they travel downstream on the shaker as they are less susceptible to the slowing effects of the drilling fluid and carry a greater momentum. In other words, on the shaker bed, drilling fluid is generally resistant to acceleration forces and thus particles that are less entrained within the drilling fluid (i.e. larger particles) will generally transit the shaker bed more quickly.

Thus, for a given operating frequency, amplitude, acceleration and basket mass of the shaker bed, if the general particle size of the drill cuttings is larger, the particles will transit the shaker bed more quickly. In addition, with generally larger particles, and as taught in the prior art, the controlled application of vacuum to the shaker is important to prevent the stalling of the cuttings on the shaker and the undesired breakdown of the particles to create fines. Larger particles are more likely to create fines due to the higher impact forces between these particles.

However, for smaller drill cuttings that may be fully entrained within the drilling fluid, at a given frequency, amplitude, acceleration and basket mass of the shaker bed, it may be difficult to effect separation of the fines from the drilling fluid. That is, for a drilling fluid slurry that has a higher composition of small particles fully entrained within drilling fluid, there may be insufficient separation of the small particles over the shaker bed with a vacuum pull effective for larger particles, notwithstanding a slower transit time and the application of vacuum.

That is, in a typical scenario where vacuum pressure may be applied to cuttings over a 3-36 inch length (typical length is 24 inches) from the downstream edge of the shaker, where for average particles the total transit time of the vacuum area may be approximately 3 seconds (longer for small particles and shorter for larger particles) this area may be sufficient to effect drilling fluid separation of larger drill cuttings particles but may not be sufficient for drilling fluid separation for smaller particles. As a result, particularly when the bulk drill cuttings/drill cuttings composition changes such that the composition is characterized by smaller/finer particles, applying a steady airflow through the screen over this area, may result in significant amounts of drilling fluid not being recovered.

As a result, and in accordance with one aspect of the invention, a pulsed vacuum is selectively applied to the vacuum area of the shaker bed such that a stronger and variable vacuum force is applied to the shaker when the composition of materials on the shaker bed warrant the application of a variable vacuum force. Importantly, this vacuum force is applied in a manner that ensures a high velocity of air/fluids in the vacuum lines so as to prevent sedimentation in the lines.

More specifically, as shown in FIG. 1, the vacuum system includes a pulse valve 9 actuatable to provide a variable vacuum force to a manifold 3 operatively connected to the vacuum system. As shown in FIG. 1, the pulse valve 9 is located within the vacuum lines 4 of the vacuum system adjacent a bleed down line 5. In operation, the vacuum pump 7 draws air through the vacuum lines. The vacuum pump draws air at a rate that is higher than the desired air flow through the screen wherein the bleed down line 5 allows volumes of air to bypass the manifold. Generally, the bleed down line is operable to control the degree of bypass from the manifold such that airflow through the screen is controlled while maintaining a high flow rate through the bulk of the vacuum lines and thereby minimize the risk of clogging of the vacuum lines over time. Thus, practically 90%+ of the airflow within the vacuum system will be typically drawn through the bleed down line and up to 10% through the manifold. As a result of the positioning of the bleed down line, which is preferably positioned as close as reasonably possible to the manifold, there is a relatively high air flow rate through the majority of the system's vacuum lines. Accordingly, recovered drilling fluid within the vacuum lines is simultaneously subjected to high flow and turbulence which ensures that any fine particulates that may have passed through the screen will not settle within the vacuum lines which over time will lead to clogging of the lines.

The pulse valve 9 allows the vacuum pressure within the vacuum lines to vary to both increase and decrease the pressure in the vacuum lines such that the pressure within the vacuum manifold will increase or decrease accordingly. For example, if the valve 9 is rapidly closed, the air flow within the vacuum manifold will drop rapidly such that a lower pressure will be applied to cuttings/fluid on the shaker screen. Similarly, when the pulse valve 9 is opened, the air flow within the vacuum manifold will increase rapidly such that a higher or increasing pressure will be applied to the cutting/fluid on the shaker screen.

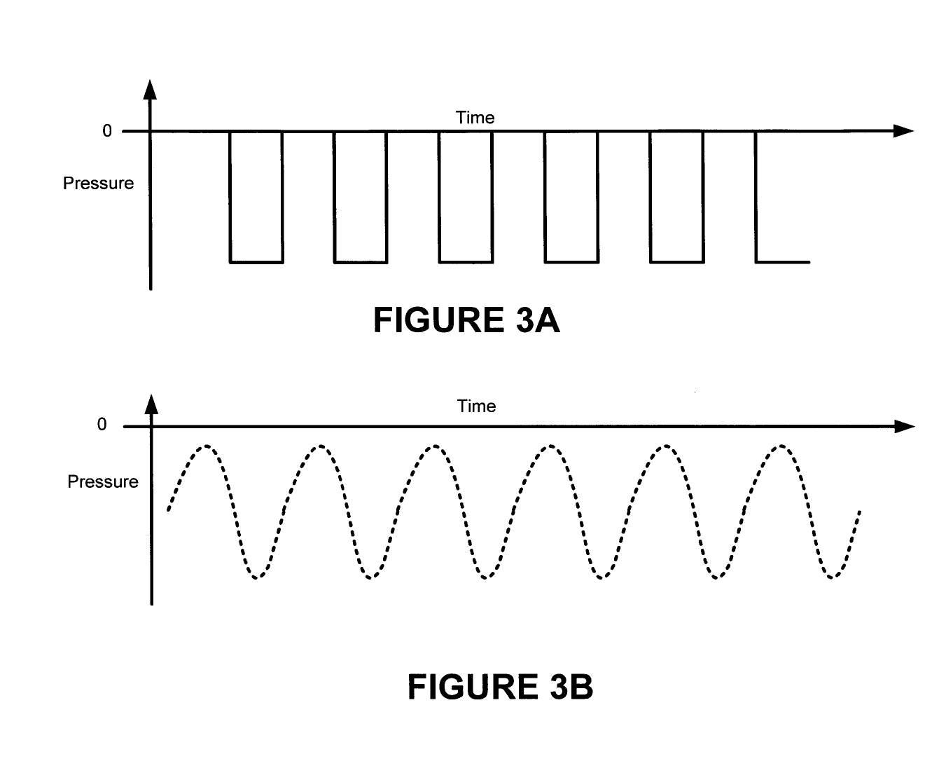

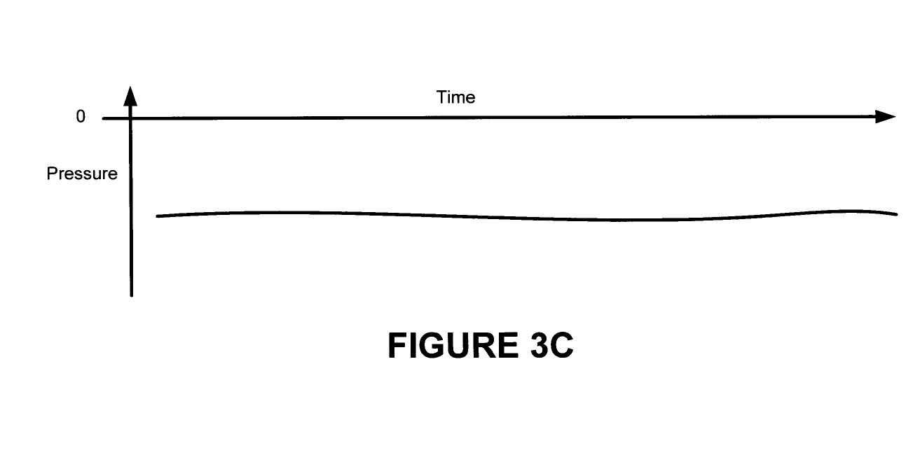

As such, a vacuum pressure profile vs. time can be created for the shaker screen based on the opening and closing of pulse valve 9. The speed with which the valve is opened and closed together with the extent of closure/opening can thereby be used to create the vacuum pressure profile. For example, as shown in FIG. 3A, a rapid and complete closure of the pulse valve 9 may create a step-like pressure profile within the vacuum manifold where the pressure abruptly varies from zero to a negative pressure value as the valve successively opens and closes. The frequency of each closing and opening cycle will be determined by the timing of each opening and closing cycle. Field observations have determined that pulses of 2-4 seconds on and 2-4 seconds off are more effective than pulses of 1 second on and 1 second off.

As shown in FIG. 3B, a different pressure profile is shown. In this case, the pulse valve 9 may be opened and closed more slowly and may not fully close for a period of time. As such, in this case, the pressure profile may be more sinusoidal and may not reach a zero pressure in the manifold. Field observations have determined that pulses of 2-4 seconds on and 2-4 seconds off are more effective than pulses of 1 second on and 1 second off. FIG. 3C shows a typical pressure profile where the pulse valve 9 remains open.

As described above, the control of manifold pressure is important to enable the vacuum system to be adjusted to ensure that the vacuum pressure is being applied at the most effective level for the current drill cuttings/drilling fluid on the shaker deck. That is, the vacuum pulse may be applied to reduce cuttings speed across the shaker deck, effect greater vacuum force to the fluids/cuttings and/or temporarily stall cuttings on the deck.

For example, an operator may determine that the current average particle is “large” and hence adjust the level of vacuum such that the pressure profile is relatively even within the manifold. However, it may also be desirable to apply a pulse in a manner to prevent lengthy stalling the drill cuttings on the shaker bed as lengthy stalling will cause the creation of fines as described above. That is, in some instances, quickly stalling and quick release of larger cuttings may be desirable.

However, as average particle size decreases, a varying pressure profile becomes more important as the smaller particles are generally more fully entrained within the drilling fluid. In this case, a varying pressure profile will subject the drilling fluid and particles to greater acceleration forces (combined vacuum forces and shaker forces) as they rapidly move against the shaker screen and rapidly stop against it such that more drilling fluid can be separated over the vacuum distance of the shaker.

As average particle size becomes very small, that is in the micron and sub-micron range, an aggressive pressure profile may be required to strip drill fluid from such small particles, including applying and releasing a high pressure on the cuttings to successively stall and release the fine cuttings on the screen. In this case, as fine cuttings are pulled into the screen, the impact of the fine cutting with the screen together with the vacuum force being applied to the surrounding drilling fluid will overcome the surface tension forces between the drill cuttings and drilling fluid and allow a greater volume of drilling fluid to be recovered. With smaller cuttings, it may be desirable to hold the cuttings against the screen for a longer period of time.

Importantly, while stalling drill cuttings on the screen, the creation of fines generally does not become an issue as the relative impact forces between slower moving fine particles (as compared to faster moving larger particles) are lower which does not cause the smaller particles to break down substantially more.

### Average Particle Size Determination and Dynamic Control

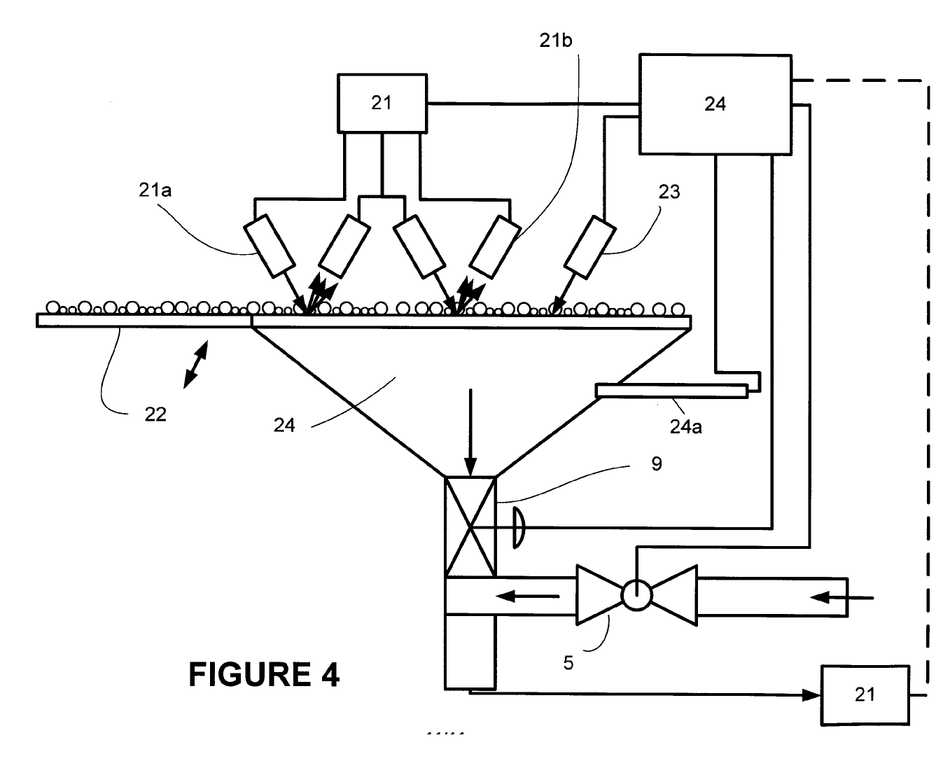

As shown in FIG. 4, a system 20 and method for the dynamic control of vacuum in the manifold is described.

As noted above, the recovery of drilling fluid can be maximized through control of the pressure profile within the manifold particularly as the average particle size varies. In accordance with another aspect of the invention, the pressure profile is dynamically changed in response to changes in the average particle size on the shaker.

As shown, mounted above the shaker deck, one or more particle size measuring devices 20a are operatively positioned above the shaker deck/screen 22 and manifold 24. Such devices may include laser diffraction equipment that project laser light against the surface of the shaker as cuttings are passing beneath. The laser diffraction measuring devices include both a laser light source 21a and a receiver 21b that collectively measure the relative refraction of laser light that can be used to estimate the average particle size of the particles on the shaker bed 22. That is, generally larger particles will cause less diffraction whereas smaller particles will cause greater diffraction of the laser light. The signal at the receiver 21b is provided to a controller 24 that calculates the average particle size for a given sampling period. The controller 24 includes appropriate control algorithms to average the signals received from the particle size measuring system to provide an average particle size determination.

In addition, the relative speed of the particles on the shaker screen can also be determined by solids flow meter 23 as a means of detecting whether or not stalling is occurring on the screen. Such solids flow meters are preferably non-contact motion sensing equipment such as solids flow meters having ultrasonic, microwave or flow disturbance type sensors. As with the particle size determination, the flow sensing equipment provides feedback to the controller to provide input regarding the relative performance of the vacuum system at a moment in time. For example, if the flow meter 23 determines that cuttings are stalling on the screen and the particle size is larger, the controller would decrease the vacuum pressure in the manifold so as to release the cuttings. Similarly, if the particle size is small and it is desired to cause stalling, the controller would increase the vacuum pressure in the manifold until stalling occurred.

As shown, the controller 24 is also operatively connected to a pressure sensor 26 within the manifold 24 that measures the relative vacuum pressure within the manifold, the pulse valve 9 and bleed valve 5.

Thus, based on the relative particle size and the mass flow rates, the controller adjusts the relative pressure within the manifold by the bleed valve and the pressure profile by the pulse valve 9 using additional feedback from the pressure sensor.

By way of further example, if the particle size system and mass flow system determines that the particles are “large” and not stalling, the optimum vacuum pressure profile may be a consistent and even air flow through the screen at a level that does not cause stalling. As such, the controller would open the pulse valve and adjust the bleed valve such that a desired vacuum pressure is realized in the manifold. In one embodiment, the controller would steadily increase the vacuum pressure until the mass flow system determined that the cuttings were stalling and then slightly reduce the vacuum pressure in the manifold.

If the particle size system determines that the particle size is getting smaller, the optimum vacuum pressure profile may the application of a moderate pulse but without stalling cuttings. In this case, the controller would open and close the pulse valve at a desired frequency to effect the desired pressure profile and adjust the bleed valve such that the upper and lower limits of the desired pressure profile are realized within the manifold. Similarly, the mass flow system will provide input into the system to effect control.

If the particle size system determines that the particle is “small”, the optimum vacuum pressure profile may be application of an aggressive pulse that causes stalling of the cuttings on the screen with a longer period of stalling. In this case, the controller would open and close the pulse valve at a desired frequency to effect the desired pressure profile and, as above, adjust the bleed valve such that the upper and lower limits of the desired pressure profile are realized within the manifold.

Generally, for each of the above, it is assumed that the vacuum pump system is operating at a fixed rate. However, it may also be possible to increase or decrease the vacuum pressure as a further control parameter for the above.

In each case, it is important that the relative flow in the vacuum line is sufficiently high to ensure the transport of any solids that may otherwise accumulate in the vacuum lines. Thus, to effect an aggressive vacuum, it is generally not desirable to close down the bleed line to an extent that the relative flow rates within the vacuum line is significantly diminished.

### Bleed Control and Fluid Conveyance for Single and Multiple Shakers

As shown in FIGS. 1, 1A, 1B and 1C, a single shaker is configured to a vacuum system 7. FIGS. 2-2C show different configurations that provide pulse and/or bleed control to the vacuum manifolds. In FIG. 1 the pulse valve changes the vacuum in the manifold and the air transport velocity is controlled directly by the bleed down lines 5 and 6. The bleed down line 5 ensures that when pulse valve 9 is closed rendering airflow to the manifold to zero or a low rate that high speed air would still be entering in the downstream area from the pulser ensuring effective slurry transport. The use of dual bleed downs on a single shaker can also provide enhanced tuning particularly when smaller vacuum lines are used. That is, in a typical operation, 2 inch transport lines are preferred in order to ensure high transport velocities. In this case, a single bleed down may not be sufficient. While larger 3 inch lines can be used with a single bleed, transport efficiencies typically will decline.

As shown in FIGS. 2, 2A, 2B and 2C, multiple shakers may be configured together through a common vacuum system 7. FIGS. 2-2C show different configurations that provide pulse and/or bleed control to the vacuum manifolds.

As shown in FIG. 1, the shaker 10 includes a screen 2 and a vacuum manifold 3 with a connected vacuum line 4. The vacuum line 4 is connected to the vacuum system 7. In this configuration, two bleed valves 5 and 6 are incorporated into the vacuum lines with bleed valve 5 located close to the manifold and bleed valve 6 being located further away from the manifold. The bleed valve 6 enables coarse tuning of the vacuum system whereas bleed valve 5 provides fine tuning of the vacuum system. A pulse valve 9 is located close to the manifold. In this configuration, a pulse profile can be applied to the manifold and the pressure in the manifold can be tuned by the bleed valves 5 and 6.

In FIG. 1A, no pulse valve is included but two bleed valves 5 and 6 are provided to enable coarse and fine tuning while still maximizing transport velocities.

In FIG. 1B, an additional pulse valve 9 is located adjacent the bleed valve 6. If implemented, this configuration could be used to synchronize the pulse profile at the different locations. In FIG. 1B the pulse valve 9 near the manifold 3 controls the airflow in the manifold while the pulse valve 9 located near the bleed line 6 increases air flow rate to increase air velocity in the lines between valve 5 and the vacuum 7 improving slurry transport. This format would typically vary the vacuum between 0 and some higher value in the manifold 3

In FIG. 1C, the pulse valve 9 is located adjacent the bleed valve 6 and could be used to control the pulse profile within the manifold. In FIG. 1C the pulse valve 9 located near the bleed line 6 increases air flow rate to increase air velocity in the lines between valve 5 and the vacuum system 7 improving slurry transport as well as varying the vacuum in the manifold 3. This format would not achieve a zero vacuum in the manifold 3

As shown in FIG. 2, two shakers 10 are configured to a common vacuum system 7. In this configuration, each shaker includes a pulse valve 9 and bleed valve 5. A common bleed valve 6 is provided between the two shakers. In addition, an optional baffle 8 may be provided at the connection point in the vacuum lines for the two shakers. The combination of the bleed valve 6 and baffle helps to reduce or eliminate the effect of changes in pressure in one manifold on the other manifold. This effect is often referred to as “tugging”. As such, to the extent that different pressures are desired in the different manifolds, the common bleed valve 6, if opened to ensure a relatively high flow rate of air through this valve will ensure that a pressure change in one manifold does not immediately cause a change in pressure in the other. This configuration would also provide for a steady air velocity downstream of the pulse valve 9 to optimize slurry transport. The pulse valve 9 would be located as close as possible to the manifold 3 and would vary the air flow/vacuum between zero and some greater value. The bleed down valve 5 would ensure that when pulse valve 9 such that airflow within the manifold was zero or a low rate that high speed air would still be entering in the downstream area from the pulse valve 9 thus ensuring effective slurry transport. FIG. 2A shows a configuration as in FIG. 2 without pulse valves.

FIG. 2B shows a configuration with a common pulse valve 9 and pulse valves at each manifold In FIG. 2B the pulse valve 9 is located near the bleed valve 6 and allows air flow rate to increase in the lines between bleed valve 5 and the vacuum system 7 thereby improving slurry transport. This configuration also varies the vacuum in the manifold 3. This format would achieve a zero vacuum in the manifold 3.

FIG. 2C shows a configuration with a common pulse valve 9 and no pulse valves at each manifold. In FIG. 2C the pulse valve 9 located near the bleed valve 6 increases air flow rate to increase air velocity in the lines between valve 5 and the vacuum 7 improving slurry transport. This configuration also varies the vacuum in the manifold 3. This format would not achieve a zero vacuum in the manifold 3.

Generally, the pulse valves are solenoid valves that are open in their unenergized position such that in the event that there is a failure of the valve that a vacuum pressure can still be applied to the manifold(s).

Table 1 shows air velocities that may be employed within the system based on the rated performance of vacuum pumps. The actual flow rates may be lower due to various fluid dynamics effects including friction effects and gas compressibility. Most vacuum lines are less than 30 feet in length so these effects may be relatively small.

TABLE 1
Air Velocities based on Rated Performance of Vacuum Pumps

| | Collection | | Air | | Air Velocity | |
|---|---|---|---|---|---|---|
| Pump | Hose ID | | Volume/Min | | in Hose | |
| Fruitland | 0.17 | 0.05 | 300 | 8.40 | 4144 | 13595 |
| 500 | ft | m | cfm | m³/min | m/min | ft/min |

### Humidity

During shaker operations, high humidity areas around the shaker are often created as a result of the heat from the drilling fluid and the action of the shaker in releasing water vapor during drilling operations. The temperature of the drilling fluid can be as high as 30° C. to 50° C. and the relative humidity can be 100%. During winter operations, the surrounding air temperature can be as low as −50° C. These conditions can result in freezing of lines and valves particularly at locations where cold air comes into contact with warm humid air. With reference to FIG. 1C, these locations can include the manifold 3, bleed valves 5, 6 and solenoid valve 9. Freezing of lines and/or valves can require a system shut-down in order to unfreeze and clean this equipment.

Accordingly, as shown in FIG. 1C, warm compressed air from the vacuum system or another source may circulated to these locations to provide warming of these locations such that freezing is prevented. As shown in dotted lines in FIG. 1C, additional piping may be configured to the bleed valves 5,6 to provide a warm air supply to these locations. In addition, warm air may be circulated above the manifold by a distribution bar 100 positioned above the manifold 3. Depending on the relative power and efficiency of the vacuum system 7, the amount of heat available from the normal operation of the vacuum pump may be sufficient to prevent freezing. In other cases, a supplemental heat source may also be configured to the vacuum system to provide additional heating. Such a heat source may include electric heat or another heat source.

Although the present invention has been described and illustrated with respect to preferred embodiments and preferred uses thereof, it is not to be so limited since modifications and changes can be made therein which are within the full, intended scope of the invention as understood by those skilled in the art.

1. A vacuum shaker system for separating a mixture of a drilling fluid from drill cuttings on a shaker screen, the vacuum shaker system comprising:
a first vacuum manifold operatively connected and substantially sealed to a portion of a shaker screen deck of a first shaker, the shaker screen deck supporting at least one shaker screen;
a vacuum pump having an air/fluid separation system operatively connected to the first vacuum manifold through a first vacuum hose, the vacuum pump operable to draw sufficient air through the first vacuum hose to move a slurry of drilling fluid and fine solids through the first vacuum hose and to apply a vacuum pressure to the underside of the shaker screen deck through the first vacuum hose; and
a first bleed valve operatively connected to the first vacuum hose adjacent the first vacuum manifold wherein the first bleed valve is operable to control the flow of air through the first vacuum manifold and wherein for a given vacuum pump flow rate, air flow is sufficient to move a slurry of drilling fluid and fine solids through the first vacuum hose and wherein restricting air flow through the first bleed valve increases vacuum pressure within the first vacuum manifold and opening air flow through the first bleed valve reduces vacuum pressure within the manifold while maintaining sufficient air flow within the first vacuum line to move a slurry of drilling fluid and fine solids through the first vacuum hose.

2. The vacuum shaker system of claim 1, further comprising a first pulse valve operatively connected to the first vacuum hose between the first bleed valve and first manifold, the first pulse valve operable to vary the vacuum pressure within the first manifold.

3. The vacuum shaker system of claim 1, further comprising a second bleed valve operatively connected to the first vacuum hose between the first bleed valve and the vacuum pump and wherein adjustment of the second bleed valve enables coarse control of the relative air flow through the first vacuum manifold.

4. The vacuum shaker system of claim 3, further comprising a second pulse valve operatively connected to the first vacuum hose adjacent the second bleed valve.

5. The vacuum shaker system of claim 1, further comprising a second shaker operatively connected to the vacuum pump, the second shaker having:
a second vacuum manifold operatively connected and substantially sealed to a portion of a shaker screen deck of the second shaker, the second shaker screen deck supporting at least one shaker screen;
a second vacuum hose operatively connected to the second vacuum manifold and to the first vacuum hose and wherein the first and second vacuum hoses are operatively connected to the vacuum pump through a common third vacuum hose; and
a second shaker bleed valve operatively connected to the second vacuum hose adjacent the second vacuum manifold wherein the second shaker bleed valve is operable to control the flow of air through the second vacuum manifold and wherein for a given vacuum pump flow rate, air flow is sufficient to move a slurry of drilling fluid and fine solids through the second vacuum hose and wherein restricting air flow through the second shaker bleed valve increases vacuum pressure within the second vacuum manifold and opening air flow through the second shaker bleed valve reduces vacuum pressure within the second manifold while maintaining sufficient air flow within the second vacuum hose to move a slurry of drilling fluid and fine solids through the second vacuum hose.

6. The vacuum shaker system of claim 5, further comprising a second shaker pulse valve operatively connected to the second vacuum hose between the second shaker bleed valve and second manifold, the second shaker pulse valve operable to vary the vacuum pressure within the second manifold.

7. The vacuum shaker system of claim 5, wherein the second bleed valve is operatively connected to the first and second vacuum hoses.

8. The vacuum shaker system of claim 6, wherein the second pulse valve is operatively connected to the first and second vacuum hoses adjacent the second bleed valve.

9. The vacuum shaker system of claim 5, further comprising a baffle operatively connected within the first and second vacuum hoses to prevent tugging between the first and second manifolds.

10. The vacuum shaker system of claim 1, further comprising:
a particle size measuring device operatively connected to the first shaker deck for measuring average particle size of particles on the shaker deck; and
a controller operatively connected to the particle size measuring device and the first bleed valve wherein the controller adjusts air flow through the first bleed valve based on a measured average particle size to change the vacuum pressure within the first manifold.

11. The vacuum shaker system of claim 10, wherein the controller is operatively connected to the first pulse valve and the controller opens and closes the first pulse valve to provide a vacuum pressure profile within the first manifold.

12. The vacuum shaker system of claim 10, further comprising a pressure sensor operatively connected to the first vacuum manifold and controller for providing pressure data to the controller.

13. The vacuum shaker system of claim 10, further comprising a mass flow meter operatively connected to the first shaker deck and controller for providing mass flow data to the controller.

14. The vacuum shaker system of claim 1, wherein warm air exhausted from the vacuum pump or another source is operatively connected to the first bleed valve.

15. The vacuum shaker system of claim 2, wherein warm air exhausted from the vacuum pump or another heat source is operatively connected to the first pulse valve.

16. The vacuum shaker system of claim 3, wherein warm air exhausted from the vacuum pump or another heat source is operatively connected to the second bleed valve.

17. The vacuum shaker system of claim 4, wherein warm air exhausted from the vacuum pump or another heat source is operatively connected to the first pulse valve.

18. The vacuum shaker system of claim 1, wherein warm air exhausted from the vacuum pump or another heat source is operatively connected to the shaker above the screen to circulate warm air over the vacuum manifold.

19. A method of maintaining solids flow within a vacuum system operatively connected to a shaker and controlling vacuum pressure with a vacuum manifold operatively connected to a shaker bed and shaker screen of a shaker, the shaker having a vacuum pump operatively connected to the vacuum manifold by a vacuum hose, the vacuum hose including a bleed valve adjacent the vacuum manifold, the method comprising the steps of:
operating the vacuum pump to maintain a high air flow rate within the vacuum hose between the vacuum pump and the bleed valve; and
adjusting the bleed valve to maintain an air flow rate sufficient to ensure the flow of liquids and fine solids within the vacuum line between the bleed valve and the vacuum pump and to maintain a desired pressure within the vacuum manifold.

20. The method of claim 19, wherein the shaker includes a pulse valve located adjacent the vacuum manifold between the bleed valve and vacuum manifold, the method further comprising controlling the pulse valve to provide a vacuum pressure profile within the vacuum manifold.

21. The method of claim 19, further comprising measuring the average particle size of drill cuttings on the shaker bed and adjusting any one of or a combination of the bleed valve or pulse valve to change the pressure and/or pressure profile within the vacuum manifold.

22. The method of claim 21, further comprising measuring the relative speed of drill cuttings on the shaker and adjusting any one of or a combination of the bleed valve or pulse valve to change the pressure and/or pressure profile within the vacuum manifold.

23. The method of claim 19, further comprising correlating the average particle size and the relative speed of drill cuttings on the shaker and adjusting any one of or a combination of the bleed valve or pulse valve to change the pressure and/or pressure profile within the vacuum manifold based on the relative size and speed of the drill cuttings.

24. The method of claim 19, further comprising adjusting the frequency of opening and closing the pulse valve to control the time that drill cuttings are stalled on the shaker screen.
